(19) United States
(12) Patent Application Publication
(10) Pub. No.: US 2010/0048754 A1
(43) Pub. Date: Feb. 25, 2010

(54) VISCOELASTIC POLYURETHANE FOAMS COMPRISING OLIGOMERIC NATURAL OIL POLYOLS

(75) Inventors: Timothy Walter Abraham, Minnetonka, MN (US); Dzung G. Dai, Maple Grove, MN (US); Ricardo De Genova, Edina, MN (US); Jeff Malsam, Minneapolis, MN (US)

Correspondence Address: CARGILL, INCORPORATED, P.O. Box 5624, MINNEAPOLIS, MN, 55440-5624, US

(73) Assignee: Cargill, Incorporated, Wayzata, MN (US)

(21) Appl. No.: 12/514,930

(22) PCT Filed: Nov. 16, 2007
(86) PCT No.: PCT/US07/24152

§ 371 Date: May 14, 2009

Related U.S. Application Data
(60) Provisional application No. 60/859,365, filed on Nov. 16, 2006.

(51) Int. Cl. C08G 18/48; C08G 18/40

(52) U.S. Cl. 521/174; 521/170

(57) ABSTRACT

Described are viscoelastic polyurethane foams that comprise an oligomeric natural oil polyol and a petroleum-derived polyol. The viscoelastic foams are formed by reacting a polyisocyanate with an active-hydrogen composition that comprises the oligomeric natural oil polyol and petroleum-derived polyol.

### CROSS-REFERENCE TO RELATED APPLICATIONS

This application claims the benefit of PCT Patent Application, Serial No. PCT/US2007/024152, filed Nov. 16, 2007, entitled VISCOELASTIC POLYURETHANE FOAMS COMPRISING OLIGOMERIC NATURAL OIL POLYOLS, which claims priority of the U.S. Provisional Patent Application, Ser. No. 60/859,365, filed Nov. 16, 2006, entitled, VISCOELASTIC POLYURETHANE FOAMS COMPRISING OLIGOMERIC NATURAL OIL POLYOLS, which are hereby incorporated by reference in their entirety.

### BACKGROUND

Viscoelastic foams make up a special grade of polyurethane foams that are characterized by displaying a low rate of recovery from an applied force and low resilience (i.e., high viscous damping) as measured, for example, by the ball rebound test. Viscoelastic foams typically have ball rebound values of less than about 20%, as compared to about 40% for conventional slabstock foams, and about 55-60% for high resilience foams. Because of their unique properties, viscoelastic foams have been used in many specialty applications such as pillows, mattresses, airplane seats, headphones, ski boots, hiking boots, packaging, helmet liners, gym mats, ear plugs and NVH (noise, vibration and harshness applications).

Typically, viscoelastic foam formulations include a polyisocyanate and an active-hydrogen composition comprising one or more petroleum-derived polyols. The petroleum-derived polyols making up the active-hydrogen composition typically have a relatively high hydroxyl number, for example, about 168 (mg KOH/gram) or greater. Because of the high hydroxyl number, these viscoelastic foams are high in isocyanate demand. That is, in order to provide a stoichiometric balance between the hydroxyl groups in the polyol and the isocyanate groups in the polyisocyanate, a relatively large amount of isocyanate must be used in these formulations. Since polyisocyanates are expensive and are difficult to handle, a reduction in the usage of polyisocyanates is highly desirable.

### SUMMARY

The present invention relates to viscoelastic polyurethane foams comprising an oligomeric natural oil polyol. The viscoelastic foams of the invention are be formed by reacting a polyisocyanate with an active-hydrogen composition that comprises an oligomeric natural oil polyol; and a petroleum-derived polyol.

In many embodiments, the oligomeric natural oil polyols are made by epoxidation and ring opening of natural oils in a manner that results in oligomerization during the ring opening reaction. Representative natural oils include, for example, soybean oil, safflower oil, linseed oil, corn oil, sunflower oil, olive oil, canola oil, sesame oil, cottonseed oil, palm oil, rapeseed oil, tung oil, peanut oil, fish oil, lard, tallow, and combinations thereof. In an exemplary embodiment, the natural oil is soybean oil.

In addition to the oligomeric natural oil polyol, the active-hydrogen composition additionally comprises a petroleum-derived polyol (e.g., a polyether triol or an ethylene oxide rich polyol) which imparts viscoelastic properties to the foam. Suitable petroleum-derived polyols (e.g., polyether triol and ethylene oxide based polyol) will typically have an average molecular weight of about 500 to about 2000 grams/mole; a hydroxyl number of about 50 to about 250 mg KOH/g; and a hydroxyl functionality of about 2.5 to about 3.5.

In many embodiments, the active-hydrogen composition typically about 10% to about 99% weight oligomeric natural oil polyol and about 1% to about 90% weight petroleum-derived polyol.

In many embodiments, the viscoelastic foams of the invention are prepared using toluene diisocyanate (TDI) as the polyisocyanate component. In exemplary embodiments, the toluene diisocyanate comprises 80% weight 2, 4 toluene diisocyanate and 20% weight 2, 6-toluene diisocyanate (i.e., 80/20 TDI). Other polyisocyanates may also be used.

In many embodiments, the viscoelastic foams of the invention are characterized by having low resiliency, for example, as measured by the ball rebound test. Typically, the resiliency of the polyurethane foams will be about 20% or less, about 10% or less, about 5% or less, or about 1% or less. Viscoelastic foams of the invention typically have a glass transition temperature (Tg), as measured by Dynamic Mechanical Analysis (DMA), that is near room temperature, for example, ranging from about −40° C. to about +40° C.

In some embodiments, the active-hydrogen composition has a low hydroxyl number (OH number) that makes the viscoelastic foams of the invention low in polyisocyanate demand. Low polyisocyanate demand is an advantage both for economic and manufacturing reasons. In viscoelastic foams of the invention, the hydroxyl number of the active-hydrogen composition is typically about 150 mg KOH/gram or less, for example, about 100 mg KOH/gram or less.

In some embodiments, the viscoelastic foams of the invention have reduced odor as compared to viscoelastic foams prepared with other naturally derived polyols. For example, the viscoelastic foams may comprise oligomeric natural oil polyols that comprise about 400 ppm or less of odor-producing compounds comprising hexanal, nonanal, and decanal.

In many embodiments, the viscoelastic foams of the invention retain their viscoelastic nature at low temperatures. This allows the viscoelastic foams of the invention to be used in low temperature applications. The improved low temperature properties of the foams may be characterized by dynamic mechanical analysis (DMA). For example, in some embodiments, the viscoelastic foams of the invention have a storage modulus (G′) of 0.141 MPa or less at −30° C. In some embodiments the viscoelastic foams have a loss modulus (G″) of about 0.091 MPa or less at −30° C.

Throughout the application, the following terms will have the following meanings.

As used herein “polyol” refers to a molecule that has an average of greater than 1.0 hydroxyl groups per molecule. It may optionally include other functionalities.

As used herein “oligomeric natural oil polyol” refers to a non-naturally occurring polyol prepared by ring-opening a fully or a partially epoxidized natural oil (such as a plant-based oil or an animal fat) in a manner that results in the formation of oligomers. Oligomeric natural oil polyols are described, for example, in U.S. Patent Publication No. 2006/0041157 and in PCT Application Nos. WO 2006/116456 and WO 2006/012344.

As used herein “oligomer” refers to two or more fatty acid ester monomer units that have been covalently bonded to one another by an oligomerizing reaction. Examples include epoxide ring-opening reaction. Oligomers include dimers, trimers, tetramers, and higher order oligomers. The term “oligomerized” refers to a material that comprises oligomers.

As used herein “active-hydrogen composition” refers to a composition that includes reactants having hydrogen atom-containing groups that are capable of reacting with isocyanate groups. Examples of hydrogen atom containing-groups include alcohols (e.g., polyols such as oligomeric polyols), amines (e.g., polyamines), and water.

As used herein “petroleum-derived polyol” refers to a polyol manufactured from a petroleum feedstock.

As used herein “viscoelastic” refers to polyurethane foams that display a slow rate of return after deformation (i.e., high hysteresis), a low resilience value, or both. As used herein the term “polyurethane foam” refers to cellular products obtained by reacting a polyisocyanate with an active hydrogen composition, using foaming agents, and in particular includes cellular products obtained with water as reactive foaming agent (involving a reaction of water with isocyanate groups yielding urea linkages and carbon dioxide and producing polyurea-urethane foams).

### BRIEF DESCRIPTION OF THE DRAWINGS

FIGS. 1-3 are dynamic mechanical analysis (DMA) curves for polyurethane foam samples of Examples 1-3.

### DETAILED DESCRIPTION

The invention describes viscoelastic polyurethane foams comprising the reaction product of: (a) a polyisocyanate; and (b) an active-hydrogen composition comprising an oligomeric natural oil polyol and a petroleum-derived polyol (e.g., a polyether triol or an ethylene oxide (EO) based polyol. The components making up the viscoelastic polyurethane foams are described in more detail below.

### Oligomeric Natural Oil Polyols

In exemplary embodiments, the oligomeric natural oil polyols are prepared from a reaction mixture comprising: (1) an epoxidized natural oil, (2) a ring-opening acid catalyst, and (3) a ring-opener. Examples of oligomeric natural oil polyols are described, for example, in PCT Application No. WO 2006/012344 (Petrovic et al.) and WO 2006/116456 (Abraham et al.). These oligomeric natural oil polyols are described in more detail below.

### Epoxidized Natural Oil

The first component is an epoxidized natural oil. Epoxidized natural oils include, for example, epoxidized plant-based oils (e.g., epoxidized vegetable oils) and epoxidized animal fats. The epoxidized natural oils may be partially or fully epoxidized. Partially epoxidized natural oil may include at least about 10%, at least about 20%, at least about 25%, at least about 30%, at least about 35%, at least about 40% or more of the original amount of double bonds present in the oil. The partially epoxidized natural oil may include up to about 90%, up to about 80%, up to about 75%, up to about 70%, up to about 65%, up to about 60%, or fewer of the original amount of double bonds present in the oil. Fully epoxidized natural oil may include up to about 10%, up to about 5%, up to about 2%, up to about 1%, or fewer of the original amount of double bonds present in the oil.

Examples of natural oils include plant-based oils (e.g., vegetable oils) and animal fats. Examples of plant-based oils include soybean oil, safflower oil, linseed oil, corn oil, sunflower oil, olive oil, canola oil, sesame oil, cottonseed oil, palm oil, rapeseed oil, tung oil, peanut oil, and combinations thereof. Animal fats may also be used, for example, fish oil, lard, and tallow. Natural vegetable oils may be used, and also useful are partially hydrogenated vegetable oils and genetically modified vegetable oils, including high oleic safflower oil, high oleic soybean oil, high oleic peanut oil, high oleic sunflower oil, and high erucic rapeseed oil (crambe oil). The number of double bonds per molecule in a natural oil may be quantified by the iodine value (IV) of the oil. For example, a vegetable oil having one double bond per molecule corresponds to an iodine value of about 28. Soybean oil typically has about 4.6 double bonds/molecule and has an iodine value of about 127-140. Canola oil typically has about 4.1 double bonds/molecule and has an iodine value of about 115. Typically, iodine values for the vegetable oils will range from about 40 to about 240. In some embodiments, vegetable oils having an iodine value greater than about 80, greater than about 100, or greater than about 110 are used. In some embodiments, vegetable oils having an iodine value less than about 240, less than about 200, or less than about 180 are used.

Useful natural oils comprise triglycerides of fatty acids. The fatty acids may be saturated or unsaturated and may contain chain lengths ranging from about C₁₂ to about C₂₄. Unsaturated fatty acids include monounsaturated and polyunsaturated fatty acids. Common saturated fatty acids include lauric acid (dodecanoic acid), myristic acid (tetradecanoic acid), palmitic acid (hexadecanoic acid), steric acid (octadecanoic acid), arachidic acid (eicosanoic acid), and lignoceric acid (tetracosanoic acid). Common monounsaturated fatty acids include palmitoleic (a C₁₆ unsaturated acid) and oleic (a C₁₈ unsaturated acid). Common polyunsaturated fatty acids include linoleic acid (a C₁₈ di-unsaturated acid), linolenic acid (a C₁₈ tran-unsaturated acid), and arachidonic acid (a C₂₀ tetra-unsaturated acid). The triglyceride oils are made up of esters of fatty acids in random placement onto the three sites of the trifunctional glycerine molecule. Different vegetable oils will have different ratios of these fatty acids. The ratio of fatty acid for a given vegetable oil will also vary depending upon such factors, for example, as where the crop is grown, maturity of the crop, weather during the growing season, etc. Because of this it is difficult to provide a specific or unique composition for any given vegetable oil, rather the composition is typically reported as a statistical average. For example, soybean oil contains a mixture of stearic acid, oleic acid, linoleic acid, and linolenic acid in the ratio of about 15:24:50:11. This translates into an average molecular weight of about 800-860 grams/mole, an average number of double bonds of about 4.4 to about 4.7 per triglyceride., and an iodine value of about 120 to about 140.

In an exemplary embodiment, the epoxidized natural oil is fully epoxidized soybean oil. Although not wishing to be bound by theory, it is believed that the use of saturated epoxidized vegetable oils having residual epoxy groups leads to oligomeric natural oil polyols having good oxidative stability. It is also believed that the use of unsaturated epoxidized vegetable oils leads to oligomeric natural oil polyols having a lower viscosity as compared to products prepared using saturated epoxidized vegetable oils.

A partially epoxidized or fully epoxidized natural oil may be prepared by a method that comprises reacting a natural oil with a peroxyacid under conditions that convert a portion of or all of the double bonds of the oil to epoxide groups.

Examples of peroxyacids include peroxyformic acid, peroxyacetic acid, trifluoroperoxyacetic acid, benzyloxyperoxyformic acid, 3,5-dinitroperoxybenzoic acid, m-chloroperoxybenzoic acid, and combinations thereof. In some embodiments, peroxyformic acid or peroxyacetic acid are used. The peroxyacids may be added directly to the reaction mixture, or they may be formed in-situ by reacting a hydroperoxide with a corresponding acid such as formic acid, benzoic acid, fatty acids (e.g., oleic acid), or acetic acid. Examples of hydroperoxides that may be used include hydrogen peroxide, tert-butylhydroperoxide, triphenylsilylhydroperooxide, cumylhydroperoxide, and combinations thereof. In an exemplary embodiment, hydrogen peroxide is used. Typically, the amount of acid used to form the peroxyacid ranges from about 0.25 to about 1.0 moles of acid per mole of double bonds in the vegetable oil, more typically ranging from about 0.45 to about 0.55 moles of acid per mole of double bonds in the vegetable oil. Typically, the amount of hydroperoxide used to form the peroxy acid is about 0.5 to about 1.5 moles of hydroperoxide per mole of double bonds in the vegetable oil, more typically about 0.8 to about 1.2 moles of hydroperoxide per mole of double bonds in the vegetable oil.

Typically, an additional acid component is also present in the reaction mixture. Examples of such additional acids include sulfuric acid, toluenesulfonic acid, trifluoroacetic acid, fluoroboric acid, Lewis acids, acidic clays, or acidic ion exchange resins.

Optionally, a solvent may be added to the reaction. Useful solvents include chemically inert solvents, for example, aprotic solvents. These solvents do not include a nucleophile and are non-reactive with acids. Hydrophobic solvents, such as aromatic and aliphatic hydrocarbons, are particularly desirable. Representative examples of suitable solvents include benzene, toluene, xylene, hexane, isohexane, pentane, heptane, and chlorinated solvents (e.g., carbon tetrachloride). In an exemplary embodiment, toluene is used as the solvent. Solvents may be used to reduce the speed of reaction or to reduce the number of side reactions. In general, a solvent also acts as a viscosity reducer for the resulting composition.

Subsequent to the epoxidation reaction, the reaction product may be neutralized. A neutralizing agent may be added to neutralize any remaining acidic components in the reaction product. Suitable neutralizing agents include weak bases, metal bicarbonates, or ion-exchange resins. Examples of neutralizing agents that may be used include ammonia, calcium carbonate, sodium bicarbonate, magnesium carbonate, amines, and resin, as well as aqueous solutions of neutralizing agents. Typically, the neutralizing agent will be an anionic ion-exchange resin. One example of a suitable weakly-basic ion-exchange resin is sold under the trade designation “LEWATIT MP-64” (from Bayer). If a solid neutralizing agent (e.g., ion-exchange resin) is used, the solid neutralizing agent may be removed from the epoxidized vegetable oil by filtration. Alternatively, the reaction mixture may be neutralized by passing the mixture through a neutralization bed containing a resin or other materials. Alternatively, the reaction product may be repeatedly washed to separate and remove the acidic components from the product. In addition, on or more of the processes may be combined in neutralizing the reaction product. For example, the product could be washed, neutralized with a resin material, and then filtered.

Subsequent to the epoxidation reaction, excess solvents may be removed from the reaction product (i.e., fully epoxidized vegetable oil). The excess solvents include products given off by the reaction, or those added to the reaction. The excess solvents may be removed by separation, vacuum, or other method. Preferably, the excess solvent removal will be accomplished by exposure to vacuum.

Useful fully-epoxidized soybean oils include those commercially available under the trade designations EPOXOL 7-4 (from American Chemical Systems) and FLEXOL ESO (from Dow Chemical Co.).

### Ring-Opening Acid Catalyst

The second component of the reaction mixture is typically a ring-opening acid catalyst. In some embodiments, the acid catalyst is fluoroboric acid (HBF₄). The acid catalyst is typically present in an amount ranging from about 0.01% to about 0.3% by weight, more typically ranging from about 0.05% to about 0.15% by weight based upon the total weight of the reaction mixture.

### Ring-Opener

The third component of the reaction mixture is a ring-opener. Various ring-openers may be used including alcohols, water (including residual amounts of water), and other compounds having one or more nucleophilic groups. Combinations of ring-openers may be used. In some embodiments, the ring-opener is a monohydric alcohol. Representative examples include methanol, ethanol, propanol (including n-propanol and isopropanol), and butanol (including n-butanol and isobutanol), and monoalkyl ethers of ethylene glycol (e.g., methyl cellosolve, butyl cellosolve, and the like). In an exemplary embodiment, the alcohol is methanol. In some embodiments, the ring-opener is a polyol. For use in flexible foams, it is generally preferred to use polyols having about 2 or less hydroxyl groups per molecule. Polyol ring-openers useful in making oligomeric natural oil polyols for use in flexible foams include, for example, ethylene glycol, propylene glycol, 1,3-propanediol, butylene glycol, 1,4-butane diol, 1,5-pentanediol, 1,6-hexanediol, polyethylene glycol, and polypropylene glycol. Also useful are vegetable oil-based polyols.

### Ring-Opening Reaction

The ring-opening reaction is conducted with a ratio of ring-opener to epoxide that is less than stoichiometric in order to promote oligomerization of the resulting ring-opened polyol. In an exemplary embodiment, an oligomeric natural oil polyol is prepared by reacting fully epoxidized soybean oil (ESBO) with methanol in the presence of a ring-opening catalyst, for example, fluoroboric acid. Typically, the molar ratio of methanol to fully epoxidized soybean oil will range from about 0.5 to about 3.0, more typically ranging from about 1.0 to about 2.0. In an exemplary embodiment, the molar ratio of the methanol to the epoxidized soybean oil ranges from about 1.3 to about 1.5.

Typically, at the start of the reaction, the fully epoxidized soybean oil has an epoxide oxygen content (EOC) ranging from about 6.8% to about 7.4%. The ring-opening reaction is preferably stopped before all of the epoxide rings are ring-opened. For some ring-opening catalyst, the activity of the catalyst decreases over time during the ring-opening reaction. Therefore, the ring-opening catalyst may be added to the reactive mixture at a controlled rate such that the reaction stops at (or near) the desired endpoint EOC. The ring-opening reaction may be monitored using known techniques, for example, hydroxyl number titrationi (ASTM E1899-02) or EOC titration (AOCS Cd9-57 method).

Typically, when fully epoxidized soybean oil is used, the ring-opening reaction is stopped when the residual epoxy oxygen content (EOC) ranges from about 0.01% to about 6.0%, for example, about 0.5% to about 5.5%, about 1% to about 5.0%, about 2% to about 4.8%, about 3% to about 4.6%, or about 4.0% to about 4.5%. When other epoxidized natural oils are used, the residual epoxy oxygen content (EOC) of the polyol may be different. For example, for palm oil, the residual EOC may range from about 0.01% to about 3.5%, for example, about 0.2% to about 3.0%, about 0.5% to about 2.0%, or about 0.8% to about 1.5%. As used herein “epoxy oxygen content” or “EOC” refers to the weight of epoxide oxygen in a molecule expressed as percentage.

During the ring-opening reaction, some of the hydroxyl groups of the ring-opened polyol react with epoxide groups that are present on other molecules in the reactive mixture (e.g., molecules of unreacted fully epoxidized soybean oil or molecules of polyol having unreacted epoxide groups) resulting in oligomerization of the polyol (i.e., the formation of dimers, trimers, tetramers, and higher order oligomers). The degree of oligomerization contributes to the desired properties of the oligomeric natural oil polyol including, for example, number average hydroxyl functionality, viscosity, and the distance between reactive hydroxyl groups. In some embodiments, the oligomeric natural oil polyol comprises about 40% weight or greater oligomers (including dimers, trimers, and higher order oligomers). In some embodiments, the oligomeric natural oil polyol comprises about 35% to about 45% weight monomeric polyol and about 55% to about 65% weight oligomers (e.g., dimers, trimers, tetramers, and higher order oligomers). For example, in some embodiments, the oligomeric natural oil polyol comprises about 35% to about 45% weight monomeric polyol, about 8% to about 12% weight dimerized polyol, about 5% to about 10% weight trimerized polyol, and about 35% weight or greater of higher order oligomers.

Oligomerization may be controlled, for example, by catalyst concentration, reactant stoichiometry, and degree of agitation during ring-opening. Oligomerization tends to occur to a greater extent, for example, with higher concentrations of catalyst or with lower concentration of ring-opener (e.g., methanol). Upon completion of the ring-opening reaction, any unreacted methanol is typically removed, for example, by vacuum distillation. Unreacted methanol is not desirable in the oligomeric natural oil polyol because it is a monofunctional species that will end-cap the polyisocyanate. After removing any excess methanol, the resulting polyol is typically filtered, for example, using a 50 micron bag filter in order to remove any solid impurities.

### Properties of the Oligomeric Natural Oil Polyols

In many embodiments, the oligomeric natural oil polyols have a low number average hydroxyl functionality. Number average hydroxyl functionality refers to the average number of pendant hydroxyl groups (e.g., primary, secondary, or tertiary hydroxyl groups) that are present on a molecule of the polyol. In some embodiments, the oligomeric natural oil polyol has a number average hydroxyl functionality (Fn) about 2.7 or less, for example, about 2.6 or less, about 2.5 or less, about 2.4 or less, about 2.3 or less, about 2.2 or less, about 2.1 or less, about 2.0 or less, about 1.9 or less, about 1.8 or less, about 1.7 or less, about 1.6 or less, about 1.5 or less, or about 1.4 or less. Typically, the number average hydroxyl functionality ranges from about 1.5 to about 2.4 or from about 1.7 to about 2.2.

In many embodiments, the oligomeric natural oil polyol has a hydroxyl number (OH number) that ranges from about 45 to about 65 mg KOH/g, or from about 55 to about 65 mg KOH/g. Hydroxyl number indicates the number of reactive hydroxyl groups available for reaction. It is expressed as the number of milligrams of potassium hydroxide equivalent to the hydroxyl content of one gram of the sample. A hydroxyl number in the range of about 45 to about 65 mgKOH/g is desirable because it reduces the usage of isocyanate in the formulation as compared to polyols having a higher hydroxyl number. In many viscoelastic compositions of the invention the oligomeric natural oil polyol replaces a portion of a petroleum-derived polyol having a significantly higher hydroxyl number thereby lowering the overall hydroxyl number of the active-hydrogen composition. For example, in some embodiments, the oligomeric natural oil polyol replaces at least a portion of a petroleum-derived polyether triol having an average molecular weight of 700 and a hydroxyl number of 238 mgKOH/g.

In many embodiments, the oligomeric natural oil polyol has a low acid value. Acid value is equal to the number of milligrams of potassium hydroxide (KOH) that is required to neutralize the acid that is present in one gram of a sample of the polyol (i.e., mg KOH/gram). A high acid value is undesirable because the acid may neutralize the amine catalyst causing a slowing of the isocyanate-polyol reaction rate. In some embodiments, the oligomeric natural oil polyol has an acid value that is less than about 5 (mg KOH/gram), for example, less than about 4 (mg KOH/gram), less than about 3 (mg KOH/gram), less than about 2 (mg KOH/gram), or less than about 1 (mg KOH/gram). In exemplary embodiments, the acid value is less than about 1 (mg KOH/gram), for example, less than about 0.5 (mg KOH/gram), or from about 0.2 to about 0.5 (mg KOH/gram).

In many embodiments, the number average molecular weight (i.e, Mn) of the oligomeric natural oil polyol is about 1000 grams/mole or greater, for example, about 1100 grams/mole or greater, about 1200 grams/mole or greater, about 1300 grams/mole or greater, about 1400 grams/mole or greater, or about 1500 grams/mole or greater. In some embodiments, the Mn is less than about 5000 grams/mole, for example, less than about 4000 grams/mole, less than about 3000 grams/mole, or less than about 2000 grams/mole. In some embodiments, the Mn ranges from about 1000-5000 grams/mole, for example, about 1200-3000 grams/mole, about 1300-2000 grams/mole, about 1700-1900 grams/mole, or about 1500-1800 grams/mole. Number average molecular weight may be measured, for example, using light scattering, vapor pressure osmometry, end-group titration, and colligative properties.

In many embodiments, the weight average molecular weight (i.e, Mw) of the oligomeric natural oil polyol is about 5000 grams/mole or greater, for example, about 6000 grams/mole or greater, about 7000 grams/mole or greater, or about 8000 grams/mole or greater. In some embodiments, the Mw is less than about 50,000 grams/mole, for example, less than about 40,000 grams/mole, less than about 30,000 grams/mole, or less than about 20,000 grams/mole. In some embodiments, the Mw ranges from about 5000-50,000 grams/mole, for example, about 5000-20,000 grams/mole, or about 6000-15,000 grams/mole. Weight average molecular weight may be measured, for example, using light scattering, small angle neutron scattering (SANS), X-ray scattering, and sedimentation velocity.

Typically the oligomeric natural oil polyol has a polydispersity (Mw/Mn) of about 3-1 5, for example, about 4-12, or about 5-10.

In many embodiments, the oligomeric natural oil polyol has a viscosity at 25° C. of about 0.5 to about 10 Pa·s. When soybean oil is used, the viscosity more typically ranges from about 2 to about 8 Pa·s, or from about 3 to about 7 Pa·s.

In many embodiments, the oligomeric natural oil polyol has few, if any, residual double bonds. This is particularly true if the oligomeric natural oil polyol is prepared from fully epoxidized soybean oil. One measure of the amount of double bonds in a substance is its iodine value (IV). The iodine value for a compound is the amount of iodine that reacts with a sample of a substance, expressed in centigrams iodine (I₂) per gram of substance (cg I₂/gram). In some embodiments, the oligomeric natural oil polyol has an iodine value that is less than about 50, for example, less than about 40, less than about 30, less than about 20, less than about 10, or less than about 5.

### Petroleum- Derived Polyol

Polyurethane compositions of the invention are formed by the reaction of a polyisocyanate with an active hydrogen composition comprising an oligomeric natural oil polyol and a petroleum-derived polyol. The petroleum-derived polyol imparts viscoelastic properties to the polyurethane foam. The petroleum-derived polyol (e.g., polyether triol or ethylene oxide (EO) rich polyol) will typically have an average molecular weight of about 500 to about 2000 grams/mole; a hydroxyl number of about 50 to about 250 mg KOH/g; and a hydroxyl functionality of about 2.5 to about 3.5. Representative examples of suitable polyether triols include polyether triols commercially available under the trade designations “VORANOL 2070” (Mn=700 grams/mole; OH number=238 mg KOH/gram; from Dow Chemical); “VORANOL 3150” (Mn=1000 grams/mole; OH number=167 mg KOH/gram; from Dow Chemical); “SOFTCEL U1000” (Mn=1000 grams/mole; OH number 168 mg KOH/gram; from Bayer); “SOFTCELL VE1000” (Mn=84 grams/mole; OH number=84 mg KOH/gram; and functionality=2.5; from Bayer); “ARCOL LHT 240” (Mn−707 grams/mole; OH number=238 mg KOH/gram; functionality 3; from Bayer); “ARCOL LG-168” (Mn=1000 grams/mole; OH number−168 mg KOH/gram; from Bayer).

Also useful are polyethylene oxide-based polyols that are rich in EO (e.g., at least 50% by weight or greater EO) such as those described in U.S. Pat. No. 6,946,497 (Yu). Representative examples include random PO/EO polyols (i.e., polyoxyethylene-polyoxypropylene polyols) having an EO content of about 50% by weight or greater (e.g., 75% by weight); an OH value of about 42 mg KOH/g; a functionality of 3; and an average equivalent weight of about 1333 grams/mole. Typically, the petroleum-derived polyol comprises about 1% to about 90% weight of the active-hydrogen composition.

In many embodiments, the active-hydrogen composition has a low hydroxyl number, for example, about 150 (mg KOH/gram) or less. In more preferred embodiments, the active-hydrogen composition has a hydroxyl number of about 100 (mg KOH/gram) or less. A low hydroxyl number is a desirable feature for the active-hydrogen composition because it reduces the total amount of polyisocyanate that is required in the viscoelastic polyurethane foam formulation. Since polyisocyanates are expensive and difficult to handle, reducing the amount of polyisocyanate is both an economic advantage and a manufacturing advantage relative to higher demand polyurethane formulations.

As know to those of skill in the art, the choice of polyols or polyol blends will be dependent on the specific properties desired in the viscoelastic foam (hardness, resilience, rate of return, compression set, etc.).

### Polyisocyanates

Polyurethane compositions of the invention are formed from polyisocyanes that are reacted with an active-hydrogen composition. Representative examples of useful polyisocyanates include those having an average of at least about 2.0 isocyanate groups per molecule. Both aliphatic and aromatic polyisocyanates can be used. Examples of suitable aliphatic polyisocyanates include 1,4-tetramethylene diisocyanate, 1,6-hexamethylene diisocyanate, 1,12-dodecane diisocyanate, cyclobutane-1,3-disocyanate, cyclohexane-1,3- and 1,4-diisocyanate, 1,5-diisocyanato-3,3,5-trimethylcyclohexane, hydrogenated 2,4-and/or 4,4′-diphenylmethane diisocyanate (H₁₂MDI), isophorone diisocyanate, and the like. Examples of suitable aromatic polyisocyanates include 2,4-toluene diisocyanate (TDI), 2,6-toluene diisocyanate (TDI), and blends thereof, 1,3- and 1,4-phenylene diisocyanate, 4,4′-diphenylmethane diisocyanate (including mixtures thereof with minor quantities of the 2,4′-isomer) (MDI), 1,5-naphthlylene diisocyanate, triphenylmethane-4,4′,4″-triisocyanate, polyphenylpolymethylene polyisocyanates (PMDI), and the like. Derivatives and prepolymers of the foregoing polyisocyanates, such as those containing urethane, carbodiimide, allophanate, isocyanurate, acylated urea, biuret, ester, and similar groups, may be used as well. Included are monomeric diisocyanates (e.g., MONDUR ML); modified isocyanates and polyisocyanates (typically having a % NCO from about 10-45). Modified isocyanates typically have a % NCO of about 10 to about 30 (e.g., MONDUR PF); allophanate modified isocyanates typically have a % NCO of about 16 to about 30 (e.g., MONDUR MA-2300); and polymeric isocyanates typically have a % NCO of about 24 to about 33 (e.g., MONDUR MRS-20). Prepolymers of TDI or MDI (e.g., RUBINATE R-7300 or R-73126 (from Huntsmann)) as well as blends of MDI and TDI are also useful.

Conventionally, in preparing viscoelastic foams, a 65%/35% blend of 2,4-toluene diisocyanate and 2,6-toluene diisocyanate (65/35 TDI) is used because this blend of TDI reacts preferentially with water allowing for the production of lower density foams having reduced shrinkage. Advantageously, viscoelastic foams of the invention may be made using an 80%/20% blend of 2,4-toluene diisocyanate and 2,6-toluene diisocyanate (80/20 TDI). This blend of isomers is substantially less expensive than 65/35 TDI and is easier to work with than 65/35 TDI.

Derivatives and prepolymers of the foregoing polyisocyanates, such as those containing urethane, carbodiimide, allophanate, isocyanurate, acylated urea, biuret, ester, and similar groups, may be used as well. The amount of polyisocyanate used is typically sufficient to provide an isocyanate index of about 60 to about 100, more typically from about 70 to about 90, and most typically from about 80 to about 85. As used herein the term “isocyanate index” refers to a measure of the stoichiometric balance between the equivalents of isocyanate used to the total equivalents of water, polyols and other reactants. An index of 100 means enough isocyanate is provided to react with all compounds containing active-hydrogen atoms.

### Other Ingredients

Other ingredient in the viscoelastic foam include, for example, melamine, acetone, catalysts (e.g., DABCO A1, DABCO 33LV, tin catalysts such as stannous octoate (T9 or K29) and dibutyltindilaurate (T12)); fillers (e.g., CaCO₃); stabilizing or cell opening surfactants; colorants; U.V. stabilizers (e.g., B-75); flame retardants (e.g., FM550 or TB195); bacteriostats, plasticizers, cell openers (e.g., Dow 4053, M-9199, or M-9198), antistatic agents, and blowing agents (e.g., acetone or methylene chloride). Typically. the amount of catalyst will range up to about 0.4% weight, for example, about 0.2% weight to about 0.4% weight.

### Manufacturing of Viscoelastic Foam

Viscoelastic foams of the invention can be manufactured using known techniques for producing viscoelastic foams. For example, in some embodiments, the reactants are mixed together and are poured onto a conveyor where the reacting mixture rises against its own weight and cures to form a slabstock bun having a nominal rectangular cross-section. The resulting bun can be cut into the desired shape to suit the end-use.

Viscoelastic foams of the invention can be manufactured using conventional slabstock foaming equipment, for example, commercial box-foamers, high or low pressure continuous foam machines, crowned block process, rectangular block process (e.g., Draka, Petzetakis, Hennecke, Planiblock, EconoFoam, and Maxfoam processes), or veiti-foam process. In some embodiments, the slabstock foam is produced under reduced pressure. For example, in variable pressure foaming (VPF), the complete conveyor section of the foaming machine is provided in an airtight enclosure. This technique allows for the control of foam density and the production of foam grades that may otherwise be difficult to produce. Details of such slabstock foaming processes are reported, for example, in Chapter 5 of Flexible Foams, edited by Herrington and Hock, (2^{nd} Edition, 1997, Dow Chemical Company).

In some instances, it is desirable to post-cure the foam after initial forming (and demolding in the case of molded foam) to develop optimal physical properties. Post-curing may take place under ambient conditions, for example, for a period of about 12 hours to 7 days; or at elevated temperature, for example, for a period of about 10 minutes to several hours.

### Viscoelastic Foam Properties

In many embodiments, the viscoelastic foams of the invention have a density (weight per unit volume) that ranges from about 1.5 to about 6 (lbs/ft³), more typically ranging from about 3 to about 5 (lbs/ft³), and most typically ranging from about 4 to about 5 (lbs/ft³). Foam may be measured, for example, in accordance with ASTM D3574.

Viscoelastic foams of the invention are low resiliency flexible polyurethane foams. Resiliency may be measured, for example, using the ball rebound test. In the ball rebound test, a steel ball of a specified mass is dropped from a fixed height onto a foam sample and the height of the ball rebound from the foam sample is recorded. The ball rebound value is equal to the rebound height attained by the steel ball expressed as a percentage of the original drop height. Ball rebound may be measured, for example, according to ASTM D3574. In many embodiments, the viscoelastic foams of the invention have a ball rebound of about 20% or less, about 15% or less, about 10% or less, about 5% or less, or about 1% or less.

Air flow may also be used to characterize the nature of the cellular structure of the viscoelastic foams of the invention. Air flow may be measured, for example, as described in ASTM D3574 (Test G). The test consists of placing a flexible foam core specimen in a cavity over a chamber and creating a specified constant air-pressure differential. The rate of flow of air required to maintain the differential is the air flow value. Foams displaying an open cellular structure typically exhibit higher air flow values than those having a closed cellular structure. In many embodiments, the viscoelastic foams of the invention have an air flow value that ranges from about 0.5 to about 5.0 ft³/minute (SCFM), more typically ranging from about 0.5 to about 2.0 ft³/minute (SCFM).

In many embodiments, the viscoelastic polyurethane foams of the invention display a desirable low odor. In some embodiments, low odor is achieved by formulating the foams without the use of an A1-type catalyst. As used herein the term “A1-type catalyst” refers to a polyurethane catalysts that comprise (dimethylaminoethyl)ether and dipropylene glycol. Examples of A1-type catalysts include “NIAX A1” which comprises about 70% (dimethylaminoethyl)ether and about 30% dipropylene glycol. Conventionally, A1-type catalysts are used to promote viscoelastic properties in polyurethanes. Polyurethane compositions of the invention are able to achieve viscoelastic properties without the need for an A1-type catalyst, thus allowing this component to be removed from the formulation. For example, in many embodiments, the viscoelastic polyurethane foams comprise about 0.1% weight or less A1-type catalyst, about 0.01% weight or less A1-type catalyst, or about 0.001% weight or less A1-type catalyst.

In many embodiments, low odor viscoelastic polyurethane foam is achieved with the use of a low odor oligomeric natural oil polyol. Polyol odor can be measured, for example, using human test panels or by measuring the amount of certain odor-producing compounds that may be present in the polyol, for example, using gas chromatography (GC) headspace analysis. Examples of odor-producing compounds include lipid oxidation products, which are typically aldehyde compounds, for example, hexanal, nonanal, and decanal. In many embodiments, oligomeric natural oil polyol has a total odor level of about 400 ppm or less of odor-producing compounds such as hexanal, nonanal, and decanal when measured by GC headspace analysis. In more preferred embodiments, the oligomeric natural oil polyol has a total odor level of about 75 ppm or less or about 20 ppm or less of odor-producing compounds such as hexanal, nonanal, and decanal when measured by GC headspace analysis.

Many properties of viscoelastic foams can be measured using dynamic mechanical analysis (DMA). Dynamic mechanical analysis is a technique used to study and characterize materials, particularly viscoelastic polymers. In DMA an oscillating force is applied to a sample and the resulting displacement of the material is measured. From this the stiffness of the sample can be measured and the modulus of the sample can be calculated. By measuring the time lag in the displacement it is also possible to determine the damping properties of the material.

In many embodiments, the viscoelastic foams of the invention display a low storage modulus (G′) and a low loss modulus (G″) at low temperatures (e.g., −30° C.). Storage and loss modulus can be measured, for example, using DMA. A low storage modulus is characteristic of a viscoelastic foam that remains soft at low temperatures. Similarly, a low loss modulus is characteristic of a viscoelastic foam that remains soft at low temperatures. In some embodiments, viscoelastic polyurethane foams of the invention display a storage modulus (G′) that is about 0.141 MPa or less at −30° C. In some embodiments, viscoelastic polyurethane foams of the invention display a loss modulus (G″) that is about 0.091 MPa or less at −30° C. By contrast, many commercially available viscoelastic foams display a storage modulus (G′) of about 7.347 MPa at −30° C. and a loss modulus (G″) of about 0.374 MPa at −30° C. This feature of the viscoelastic polyurethane foams of the invention allows these foams to be used as viscoelastic foams in cold conditions where conventional viscoelastic foams may not display viscoelastic properties.

The glass transition temperature of viscoelastic polyurethane foam can be determined by dynamic mechanical analysis (DMA). Viscoelastic foams of the invention typically have glass transition temperature that is near room temperature (i.e., 20° C.), for example, ranging from about −40° C. to about +40° C.

Other useful foam properties include a lower rate of return after deformation (i.e., lower hysteresis). Hysteresis loss is a measurement of the energy lost or absorbed by a foam when subjected to deflection. It is typically calculated by the following equation % Hysteresis (Return 25% IFD Value/Original 25% IFD Value)*100%.

Original 25% IFD may be measured in accordance with ASTM 3574(B1). Return 25% IFD may be measured in accordance with ASTM 3574 (B1), except that after measuring the 65% IFD in accordance with the test (See, Section 20.3), the deflection is decreased to 25% and the force is allowed to drift while maintaining the 25% deflection. The force is then measured after 60±3 seconds, and is reported as Return 25% IFD. Hysteresis measures the ability of a foam to dampen vibrations and is equal to the area under the stress-strain curve as a load is applied and released.

Indentation force deflection (IFD) is a measure of the load bearing quality of a foam. IFD is typically expressed in Newtons per 323 square centimeters (N/323 cm²) at a given percentage deflection of the foam. A higher force indicates a firmer foam. To obtain IFD, a 323 square centimeter circular plate is pushed into the top surface of a foam sample, stopping at a given deflection, and reading a force on the scale. For example, a 25% IFD of 150 means that a force of 150 N/323 cm² is required to compress a 100 mm thick sheet of foam to a thickness of 75 mm. IFD may be measured, for example, using ASTM D3574.

The invention will now be described with reference to the following non-limiting examples.

### Examples

INGREDIENT LIST

| | Tradename or | | |
|---|---|---|---|
| Abbreviation | Chemical | Description | Manufacturer |
| 2070 | VORANOL 2070 | A petroleum- | Dow Chemical Co. |
| | | derived nominal | |
| | | 700 molecular | |
| | | weight polyether | |
| | | triol having an OH | |
| | | number of 238 mg | |
| | | KOH/gram. | |
| 1XS-500 | 1XS-500 | A modified | Cargill, |
| | | soybean oil based | Incorporated |
| | | polyol having an | |
| | | OH number of 53- | |
| | | 59 mg KOH/gram. | |
| 945 | PLURACOL 945 | A petroleum- | BASF |
| | | derived nominal | |
| | | 4800 molecular | |
| | | weight polyether | |
| | | triol having an OH | |
| | | number of 34-36 | |
| | | mg KOH/gram. | |
| 4600 | PLURACOL 4600 | A petroleum- | BASF |
| | | derived secondary | |
| | | hydroxyl- | |
| | | terminated graft | |
| | | polyether triol | |
| | | containing about | |
| | | 44% solids of | |
| | | copolymerized | |
| | | styrene and | |
| | | acrylonitrile having | |
| | | a OH number of | |
| | | 27-31 mg | |
| | | KOH/gram. OH | |
| | | number is 30. | |
| DP-1022 | ARCOL DP-1022 | A petroleum- | Lyondell |
| | | derived polyether | |
| | | diol processing aid. | |
| MEL | Melamine | Solid FR additive | |
| RC-6366 | | Catalyst | Rhein Chemie |
| L-626 | | Silicone | GE Silicone |
| CS-23 | | Catalyst | OSI |
| K-29 | | Tin Catalyst | Toyocat |
| FM-550 | FIREMASTER 550 | Liquid FR additive | Great Lakes |
| ACETONE | Acetone | Acetone | |
| TDI | | TDI 80/20 | Bayer |

Viscoelastic foams were prepared using the formulations provided in TABLES 1-1, 2-1, and 3-1 below. The foams were prepared according to the following procedure.
1. An empty tri-pour beaker of the proper size for the amount of the desired foam formulation to be mixed was tared on a balance.
2. The required amounts of polyol, surfactant, catalysts, blowing agents and other ingredients were added to the beaker.
3. A tri-pour beaker of the proper size with the desired isocyanate was wet tared.
4. Referring to the formulation sheet, the amount of isocyanate for the desired foam index was added to the beaker.
5. The tri-pour beaker holding the polyol was placed on a mixer and was mixed for 30 seconds with the stirrer blade completely immersed to the bottom of the beaker.
6. With 6 seconds remaining in the mix time, the pre-weighed isocyanate was added to the polyol. A stopwatch was started when the isocyanate was added.
7. When the mixer stopped, the contents of the beaker were poured into a suitable size paper or plastic bucket. The foam was then allowed to rise and cure in the bucket.

### Example 1

TABLE 1-1

| Ingredient | Parts | % Weight |
|---|---|---|
| 2070 | 0 | 0 |
| 1XS-500 | 75.50 | 60.40 |
| 945 | 3.50 | 2.80 |
| 4600 | 21.00 | 16.80 |
| DP-1022 | 1.50 | 1.20 |
| MEL | 3.50 | 2.80 |
| RC-6366 | 1.25 | 1.00 |
| L-626 | 0.633 | 0.51 |
| CS-23 | 0.500 | 0.40 |
| K-29 | 0.750 | 0.60 |
| FM-550 | 13.00 | 10.40 |
| ACETONE | 2.850 | 2.28 |
| TOTAL MIX | 125.003 | 100.0 |
| TDI | 17.79 | |

Test length 300 sec
Lab Temp 70.7° F.
Lab Humidity 27%
Max Height 3.4 inches
Height Time 172 sec
% Settle 3.56%
Max Temp 140.10° F.
Temp Time 286 sec
Blow Off 196

### Example 2

TABLE 2-1

| Ingredient | Parts | % Weight |
|---|---|---|
| 2070 | 35.5 | 28.44 |
| 1XS-500 | 40.0 | 32.05 |
| 945 | 3.50 | 2.80 |
| 4600 | 21.00 | 16.83 |
| DP-1022 | 1.5 | 1.20 |
| MEL | 3.5 | 2.80 |
| RC-6366 | 1.5 | 1.20 |
| L-626 | 0.633 | 0.51 |
| CS-23 | 0.500 | 0.40 |
| K-29 | 0.300 | 0.24 |
| FM-550 | 13.00 | 10.42 |
| ACETONE | 2.850 | 2.28 |
| TOTAL MIX | 124.80 | 100% |
| TDI | 31.11 | |

Test length 158 sec
Lab Temp 74.1° F.
Lab Humidity 34%
Max Height 4.90 inches
Height Time 82 sec
% Settle 1.63%
Max Temp 181.40° F.
Temp Time 134 sec
Blow Off 65
Duration 15

### Example 3

TABLE 3-1

| Ingredient | Parts | % Weight |
|---|---|---|
| 2070 | 75.5 | 60.80 |
| 1XS-500 | 0 | 0 |
| 945 | 3.50 | 2.82 |
| 4600 | 21.00 | 16.91 |
| DP-1022 | 1.5 | 1.21 |
| MEL | 3.5 | 2.82 |
| RC-6366 | 1.15 | 0.93 |
| L-626 | 0.633 | 0.51 |
| CS-23 | 0.500 | 0.403 |
| K-29 | 0.020 | 0.02 |
| FM-550 | 13.00 | 10.47 |
| ACETONE | 2.850 | 2.30 |
| TOTAL MIX | 124.17 | 100 |
| TD1 | 36.86 | |

Test length 300 sec
Lab Temp 74.4° F.
Lab Humidity 24%
Max Height 5.29 inches
Height Time 163 sec
% Settle 3.41%
Max Temp 190.70° F.
Temp Time 273 sec
Blow Off 162
Duration 4

### DMA Testing:

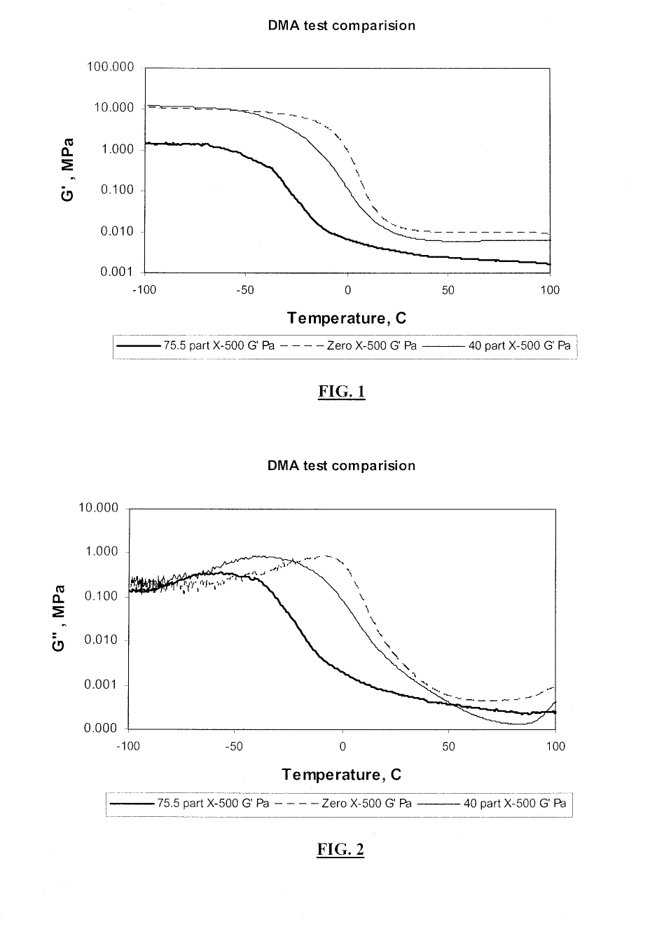

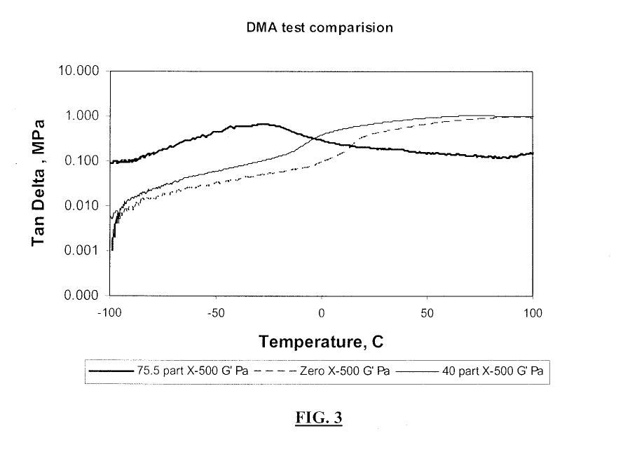

Dynamic mechanical analysis was conducted on the foam samples of Examples 1-3 in accordance with ASTM D4065 using Universal V3.9A TA instruments (model 2980) DMA V1.5B. The foams were tested from −80° C. to +120° C. at a frequency of 10 Hz and at 2.5° C./minute heating rate. The resulting DMA curves are provided in FIGS. 1-3. The table below shows the Maximum Storage Modulus (G′), Max Loss Modulus (G″), and Maximum Tan Delta for the above foam samples. Foam made with 1XS-500 gave lower G″ temperature compared with Example 3. 1XS-500 polyol helps to maintain foam hardness at lower temperature while it maintains the viscoelastic properties of the foam.

| | Example 1 | Example 2 | Example 3 |
|---|---|---|---|
| | (75 pbw | (40 pbw | (0 pbw |
| | 1XS-500) | 1XS-500) | 1XS-500) |
| Max G″ (MPa) | 0.358 | 0.862 | 0.853 |
| Max G′ (° C.) | −56.32 | −41.7 | −10.0 |
| Max Tan Delta (MPa) | 0.663 | 1.055 | 1.023 |
| Max Tan Delta (° C.) | −28.0 | 89.47 | 136.88 |

Other embodiments of this invention will be apparent to those skilled in the art upon consideration of this specification or from practice of the invention disclosed herein. Variations on the embodiments described herein will become apparent to those of skill in the relevant arts upon reading this description. The inventors expect those of skill to use such variations as appropriate, and intend to the invention to be practiced otherwise than specifically described herein. Accordingly, the invention includes all modifications and equivalents of the subject matter recited in the claims as permitted by applicable law. All patents, patent documents, and publications cited herein are hereby incorporated by reference as if individually incorporated. In case of conflict, the present specification, including definitions, will control.

1. A viscoelastic polyurethane foam comprising the reaction product of: (a) a polyisocyanate; and (b) an active-hydrogen composition comprising an oligomeric natural oil polyol and a petroleum-derived polyol.

2. The viscoelastic polyurethane foam of claim 1, wherein the active-hydrogen composition has a hydroxyl number of about 150 (mg KOH/gram) or less.

3. The viscoelastic polyurethane foam of claim 1, wherein the active-hydrogen composition has a hydroxyl number of about 100 (mg KOH/gram) or less.

4. The viscoelastic polyurethane foam of claim 1, wherein the active-hydrogen composition comprises about 10% to about 99% weight oligomeric natural oil polyol and about 1% to about 90% weight petroleum-derived polyol.

5. (canceled)

6. The viscoelastic polyurethane foam of claim 1, wherein the active-hydrogen composition comprises about 40% weight or greater of the oligomeric natural oil polyol.

7. (canceled)

8. The viscoelastic polyurethane foam of claim 1, where the petroleum-derived polyol is a polyether triol.

9-10. (canceled)

11. The viscoelastic polyurethane foam of claim 1, wherein the petroleum-derived polyol is an EO-based polyol having 50% weight or greater EO.

12-13. (canceled)

14. The viscoelastic polyurethane foam of claim 1, wherein the oligomeric natural oil polyol has a hydroxyl number of about 45 to about 65 mg KOH/gram, a number average hydroxyl functionality of less than about 2.7, and about 40% weight or greater oligomers.

15-17. (canceled)

18. The viscoelastic polyurethane foam of claim 1, wherein the oligomeric natural oil polyol has a number average hydroxyl functionality less than about 2.0.

19. (canceled)

20. The viscoelastic polyurethane foam of claim 1, wherein the oligomeric natural oil polyol has a number average molecular weight (Mn) of about 1,000 to 5,000 grams/mole.

21. The viscoelastic polyurethane foam of claim 1, wherein the oligomeric natural oil polyol has a weight average molecular weight (Mw) of about 5,000 to 50,000 grams/mole.

22. (canceled)

23. The viscoelastic polyurethane foam of claim 1, wherein the oligomeric natural oil polyol has a residual epoxy oxygen content of about 0.5% to about 5.0%.

24. The viscoelastic polyurethane foam of claim 1, wherein the oligomeric natural oil polyol has a residual epoxy oxygen content of about 0.01% to about 5.0%.

25. (canceled)

26. The viscoelastic polyurethane foam of claim 1, wherein the polyisocyanate is toluene diisocyanate.

27. The viscoelastic polyurethane foam of claim 26, wherein the toluene diisocyanate comprises 80% of 2, 4 TDI and 20% of 2, 6-TDI.

28. (canceled)

29. The viscoelastic polyurethane foam of claim 1, wherein the foam has a ball rebound value of about 20% or less.

30. The viscoelastic polyurethane foam of claim 1, wherein the foam has a ball rebound value of about 10% or less.

31-33. (canceled)

34. The viscoelastic polyurethane foam of claim 1, wherein the foam has a storage modulus (G′) of about 0.141 MPa or less at −30° C., when measured using dynamic mechanical analysis.

35. The viscoelastic polyurethane foam of claim 1, wherein the foam has a loss modulus (G″) of about 0.091 MPa or less at −30° C., when measured using dynamic mechanical analysis.

36. A viscoelastic polyurethane foam comprising the reaction product of:
(a) a polyisocyanate; and
(b) an active-hydrogen composition comprising an oligomeric natural oil polyol and a petroleum-derived polyol;wherein the oligomeric natural oil polyol has a total odor level of hexanal, nonanal, and decanal of about 400 ppm or less when measured by GC headspace analysis.

37-39. (canceled)
